(19) United States
(12) Patent Application Publication
(10) Pub. No.: US 2025/0203038 A1
(43) Pub. Date: Jun. 19, 2025

(54) Portable Television Device

(71) Applicant: Christopher Pandeli, Phoenix, AZ (US)

(72) Inventor: Christopher Pandeli, Phoenix, AZ (US)

(21) Appl. No.: 18/600,863

(22) Filed: Mar. 11, 2024

Related U.S. Application Data
(60) Provisional application No. 63/609,504, filed on Dec. 13, 2023.

(51) Int. Cl. H04N 5/64

(52) U.S. Cl. CPC H04N 5/64

(57) ABSTRACT

A portable television device is provided. The device is comprised of a portable television device designed for enhanced portability and flexibility in viewing. This device comprises an electronic display housed within a protective case featuring a lid attached via a hinge, allowing it to serve as a free-standing stand or be mounted, hung, or suspended from various surfaces or structures. The case can articulate, particularly around an exterior hinge equipped with a mounting bracket, facilitating discreet positioning when not in use. The display includes multiple connection ports, such as HDMI and ethernet, protected by removable covers. The invention may have at least three methods of utilization: positioning the device on a surface with the lid acting as a base for vertical viewing, securing the device to a surface and adjusting for optimal viewing angle, and suspending the device using a rope or similar fastener for display.

### CROSS-REFERENCE TO RELATED APPLICATION

The present application claims priority to, and the benefit of, U.S. Provisional Application No. 63/609,504, which was filed on Dec. 13, 2023, and is incorporated herein by reference in its entirety.

### FIELD OF THE INVENTION

The present invention relates generally to the field of televisions. More specifically, the present invention relates to a portable television device that can be used in a free-standing, mounted, or suspended manner in a plurality of locations. Accordingly, the present disclosure makes specific reference thereto. Nonetheless, it is to be appreciated that aspects of the present invention are also equally applicable to other like applications, devices, and methods of manufacture.

### BACKGROUND

Televisions are used by many individuals to watch a wide range of content, from movies and TV shows to news and documentaries, or to play various video games. While the primary function of a television is to provide entertainment and information, its use is often limited by its location. Although some televisions are portable, they often lack the means for easy transportation and adequate protection against the elements or impacts. This can be a significant drawback for those wanting to use their television outdoors or in non-traditional settings. Additionally, when setting up a television in unconventional spaces, users may encounter issues with a lack of suitable mounting options or stands. This absence of appropriate support structures can hinder the viewing experience and limit the utility of the television in diverse environments.

Therefore, there exists a long-felt need in the art for an improved television. There also exists a long-felt need in the art for a portable television device. More specifically, there exists a long-felt need in the art for a portable television device that is easily portable. Further, there exists a long-felt need in the art for a portable television device that is easily portable and that provides protection for the television during transport and use. In addition, there exists a long-felt need in the art for a portable television device that is easily portable and that provides protection for the television during transport and use, wherein the device can also be easily hung, suspended, or displayed in a plurality of diverse locations, areas, etc.

The subject matter disclosed and claimed herein, in one embodiment thereof, comprises a portable television device. The device is comprised of a portable television device designed for enhanced portability and flexibility in viewing. This device comprises an electronic display housed within a protective case featuring a lid attached via a hinge, allowing it to serve as a free-standing stand or be mounted, hung, or suspended from various surfaces or structures. The case can articulate, particularly around an exterior hinge equipped with a mounting bracket, facilitating discreet positioning when not in use. The display includes multiple connection ports, such as HDMI and ethernet, protected by removable covers. The invention may have at least three methods of utilization: positioning the device on a surface with the lid acting as a base for vertical viewing, securing the device to a surface and adjusting for optimal viewing angle, and suspending the device using a rope or similar fastener for display.

In this manner, the portable television device of the present invention accomplishes all the foregoing objectives and provides an improved television. More specifically, the device that provides a television that is easily portable and that provides protection for the television during transport and use. In addition, the device can be easily hung, suspended, or displayed in a plurality of diverse locations, areas, etc.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable television device. The device is comprised of at least one electronic display contained within at least one protective case, wherein the case can be opened and used as a free-standing stand or can be mounted, hung, or suspended from a surface or other structure. The body of the case is further comprised of at least one lid that attaches to the body via at least one lid hinge. In one embodiment, the lid can be opened and positioned perpendicular to the body (such that the body forms an L-like shape) to allow the lid to act as a free-standing base. This allows the screen to be viewed in a vertical manner similar to a normal television.

In another embodiment, the exterior surface of the body may be comprised of at least one exterior hinge with at least one attached mounting bracket that can be secured to a surface. Further, the hinge allows the body to articulate (preferably at least 90 degrees around the hinge) to allow the device to be positioned out of view.

The screen may also be comprised of at least one connection port. The port may include, but is not limited to, an HDMI port, an ethernet port, etc., or any other connection port found on a television. The port may be protected by at least one removable cover.

The present invention is also comprised of a first method of using the device. First, a device is provided comprised of a case comprised of a body with a lid, and a display screen comprised of a battery and at least one connection port. Then, the lid can be opened and folded about at least one hinge such that the case forms a generally L-like shape, wherein the screen 120 and body are vertical and the lid is horizontal. Then, the lid can be placed on a surface such that the screen can be viewed.

In a second method of using the device, a device is provided comprised of a case comprised of a body with a lid and at least one mounting bracket, and a display screen comprised of a battery and at least one connection port. Then, the mounting bracket can be secured to a surface, such as, but not limited to, a bottom surface of a cabinet, ceiling, etc. Then, the lid can be opened and folded to expose the screen. Next, a user can manipulate the body about a hinge that secures the bracket to the body such that the screen is viewable (and is preferably perpendicular to the surface). When not in use, a user can manipulate the body about a hinge such that the screen is parallel to the surface to place the screen out of view.

The present invention is also comprised of a third method of using the device wherein a device is provided comprised of a case comprised of a body with a lid and at least one mounting bracket, and a display screen comprised of a battery and at least one connection port. Then, the mounting bracket can be suspended from a structure via securing a rope or similar fastener to the structure and to the bracket via an opening of the bracket. Then, the lid can be opened and folded to expose the screen. When not in use, the lid can be closed and secured to the body via at least one locking mechanism.

Accordingly, the portable television device of the present invention is particularly advantageous as it provides an improved television. More specifically, the device that provides a television that is easily portable and that provides protection for the television during transport and use. In addition, the device can be easily hung, suspended, or displayed in a plurality of diverse locations, areas, etc. In this manner, the portable television device overcomes the limitations of existing televisions known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a portable television device of the present invention while free-standing in accordance with the disclosed architecture;

FIG. 2 illustrates a bottom view of one potential embodiment of a portable television device of the present invention while closed in accordance with the disclosed architecture;

FIG. 3 illustrates a front view of one potential embodiment of a portable television device of the present invention while open and suspended from a structure in accordance with the disclosed architecture;

FIG. 4 illustrates a front view of one potential embodiment of a portable television device of the present invention while open and suspended attached to a bottom surface of a cabinet in accordance with the disclosed architecture;

FIG. 5 illustrates a front view of one potential embodiment of a portable television device of the present invention while closed and suspended attached to a bottom surface of a cabinet in accordance with the disclosed architecture;

FIG. 6 illustrates a rear view of one potential embodiment of a portable television device of the present invention while free-standing in accordance with the disclosed architecture;

FIG. 7 illustrates a flowchart of a method of using one potential embodiment of a portable television device of the present invention in accordance with the disclosed architecture;

FIG. 8 illustrates a flowchart of a method of using one potential embodiment of a portable television device of the present invention in accordance with the disclosed architecture; and

FIG. 9 illustrates a flowchart of a method of using one potential embodiment of a portable television device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved television. There also exists a long-felt need in the art for a portable television device. More specifically, there exists a long-felt need in the art for a portable television device that is easily portable. Further, there exists a long-felt need in the art for a portable television device that is easily portable and that provides protection for the television during transport and use. In addition, there exists a long-felt need in the art for a portable television device that is easily portable and that provides protection for the television during transport and use, wherein the device can also be easily hung, suspended, or displayed in a plurality of diverse locations, areas, etc.

The present invention, in one exemplary embodiment, is comprised of a portable television device designed for enhanced portability and flexibility in viewing. This device comprises an electronic display housed within a protective case featuring a lid attached via a hinge, allowing it to serve as a free-standing stand or be mounted, hung, or suspended from various surfaces or structures. The case can articulate, particularly around an exterior hinge equipped with a mounting bracket, facilitating discreet positioning when not in use. The display includes multiple connection ports, such as HDMI and ethernet, protected by removable covers. The invention may have at least three methods of utilization: positioning the device on a surface with the lid acting as a base for vertical viewing, securing the device to a surface and adjusting for optimal viewing angle, and suspending the device using a rope or similar fastener for display.

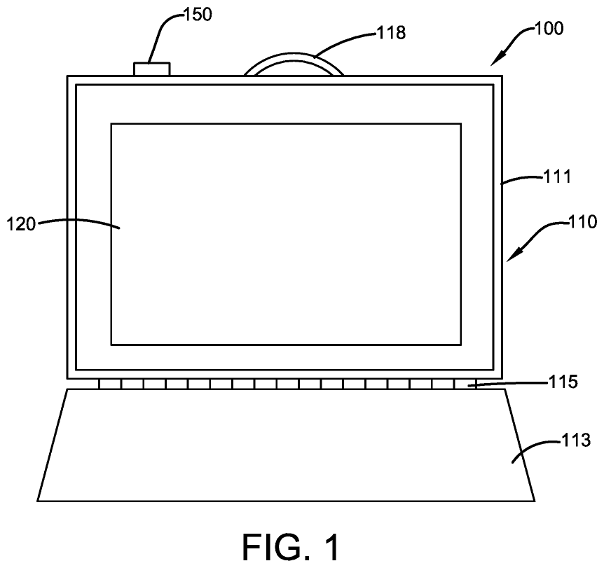

Referring initially to the drawings, FIG. 1 illustrates a front view of one potential embodiment of a portable television device 100 of the present invention while free-standing in accordance with the disclosed architecture. The device 100 is comprised of at least one electronic display 120 contained within at least one protective case 110. The case 110 can be opened and used as a free-standing stand or can be mounted, hung, or suspended from a surface or other structure.

The case 110 may be any shape and may be made from any material. However, the case 110 is preferably made from a waterproof plastic or a waterproof metal. Further, the entire case 110 is preferably water-sealed to protect at least one display screen 120 within the case 110 body 111 from becoming wet if left outdoors. The screen 120 may be any type of electronic display screen known in the art.

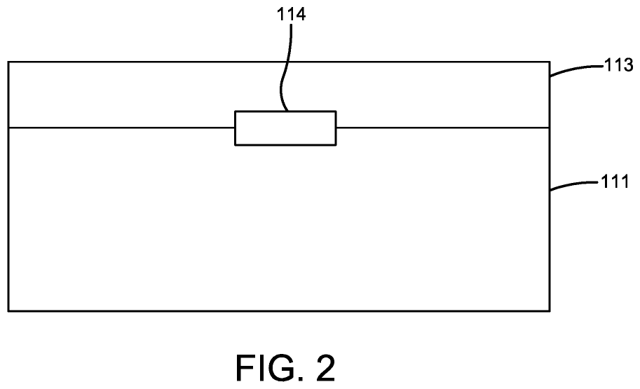

The body 111 of the case 110 is further comprised of at least one lid 113 that attaches to the body 111 via at least one lid hinge 115. The hinge 115 may be any hinge type known in the art. The lid 113 can be secured to the body 111 (for storage, transport, etc.) via at least one locking mechanism 114, such as, but not limited to, a lock, a latch, a clasp, etc., as seen in FIG. 2. The body 110 may also be comprised of at least one handle 118 (of any type) to allow the device 100 to be carried.

In one embodiment, the lid 113 can be opened and positioned perpendicular to the body 111 (such that the body 110 forms an L-like shape) to allow the lid 113 to act as a free-standing base, as seen in FIG. 1. This allows the screen 120 to be viewed in a vertical manner similar to a normal television.

In another embodiment, the exterior surface 112 of the body 110 may be comprised of at least one exterior hinge 116 with at least one attached mounting bracket 117. The bracket 117 is comprised of at least one opening 1170 that allows at least one fastener to pass through the bracket 117 to secure the bracket 117 to a surface. Further, the hinge 116 allows the body 111 to articulate (preferably at least 90 degrees around the hinge 116) to allow the device 100 to be positioned out of view.

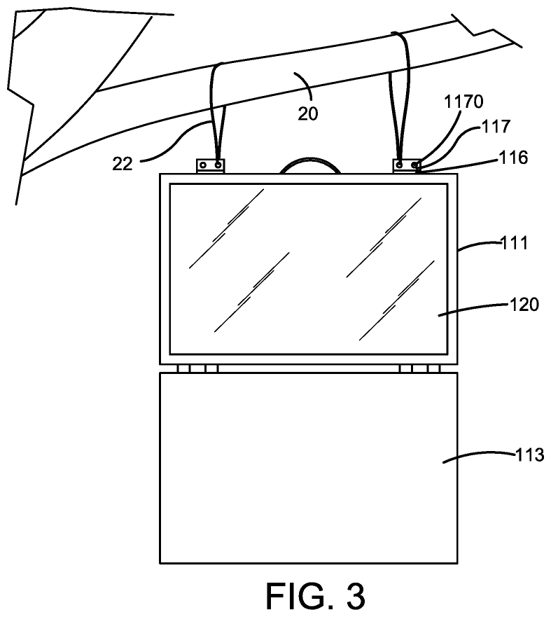

In a further embodiment, the opening 1170 allows a rope 22, tie, etc., to be placed through the bracket 117 in order to hang/suspend the device 100 from a structure, as seen in FIG. 3. In this manner, the device 100 can be mounted in a plurality of locations.

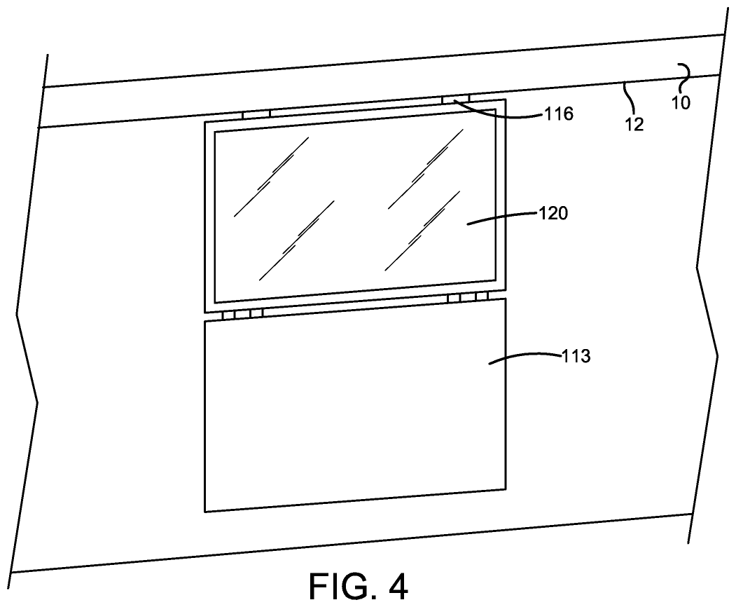

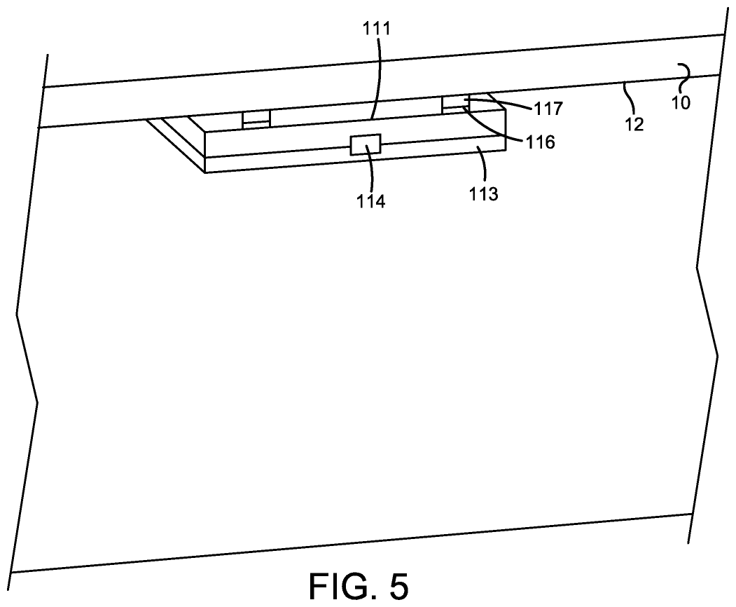

By way of example, in an embodiment wherein the bracket 117 is secured to the bottom surface 12 of a cabinet 10, the body 111 can be folded downwards (such that the body 111 is perpendicular to the bottom surface 12) and the lid 113 can be opened to allow a user to view the screen 120, as seen in FIG. 4. When finished viewing the screen 120, the lid 113 can be closed and the body 110 can be articulated about the hinge 116 such that it is parallel with the bottom surface 12, as seen in FIG. 5.

The screen 120 may be powered by at least one battery 130. The battery 130 may be removable or non-removable from the screen 120 in different embodiments. The battery 130 may also be rechargeable or disposable. In another embodiment, the battery 130 is comprised of at least one charging port 131, of any type known in the art such as, but not limited to, USB. In another embodiment, the battery 130 can be powered/charged via at least one power cord 132 (of any type). In one embodiment, the battery 130 is powered by at least one solar panel 150 positioned anywhere on the device 100.

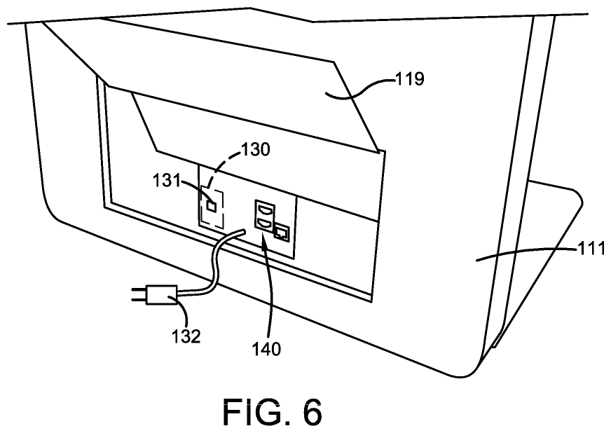

The screen 120 may also be comprised of at least one connection port 140, as seen in FIG. 6. The port 140 may include, but is not limited to, an HDMI port, an ethernet port, etc., or any other connection port found on a television. The port 140 may be protected by at least one removable cover 119.

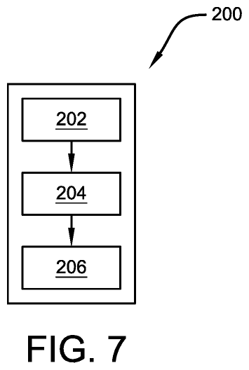

The present invention is also comprised of a method of using 200 the device 100, as seen in FIG. 7. First, a device 100 is provided comprised of a case 110 comprised of a body 111 with a lid 113, and a display screen 120 comprised of a battery 130 and at least one connection port 140 [Step 202]. Then, the lid 113 can be opened and folded about at least one hinge 115 such that the case 110 forms a generally L-like shape, wherein the screen 120 and body 111 are vertical and the lid 113 is horizontal [Step 204]. Then, the lid 113 can be placed on a surface such that the screen 120 can be viewed [Step 206].

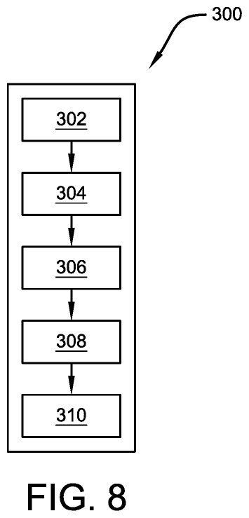

The present invention is also comprised of a second method of using 300 the device 100, as seen in FIG. 8. First, a device 100 is provided comprised of a case 110 comprised of a body 111 with a lid 113 and at least one mounting bracket 117, and a display screen 120 comprised of a battery 130 and at least one connection port 140 [Step 302]. Then, the mounting bracket 117 can be secured to a surface, such as, but not limited to, a bottom surface 12 of a cabinet 10, ceiling, etc. [Step 304]. Then, the lid 113 can be opened and folded to expose the screen 120 [Step 306]. Next, a user can manipulate the body 111 about a hinge 116 that secures the bracket 117 to the body 111 such that the screen 120 is viewable (and is preferably perpendicular to the surface 12) [Step 308]. When not in use, a user can manipulate the body 111 about a hinge 116 such that the screen 120 is parallel with the surface 12 to place the screen 120 out of view [Step 310].

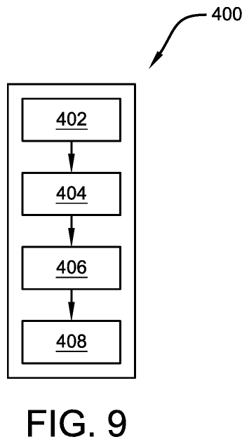

The present invention is also comprised of a third method of using 400 the device 100, as seen in FIG. 9. First, a device 100 is provided comprised of a case 110 comprised of a body 111 with a lid 113 and at least one mounting bracket 117, and a display screen 120 comprised of a battery 130 and at least one connection port 140 [Step 402]. Then, the mounting bracket 117 can be suspended from a structure 20 via securing a rope 22 or similar fastener to the structure 20 and to the bracket 117 via an opening 1170 of the bracket 117 [Step 404]. Then, the lid 113 can be opened and folded to expose the screen 120 [Step 406]. When not in use, the lid 113 can be closed and secured to the body 111 via at least one locking mechanism 114 [Step 408].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable television device” and “device” are interchangeable and refer to the portable television device 100 of the present invention.

Notwithstanding the foregoing, the portable television device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the portable television device 100 as shown in the FIGS. are for illustrative purposes only, and that many other sizes and shapes of the portable television device 100 are well within the scope of the present disclosure. Although the dimensions of the portable television device 100 are important design parameters for user convenience, the portable television device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable television device comprising:
a case comprised of a body;
a lid attached to the body via a hinge;
a display screen; and
a battery.

2. The portable television device of claim 1, wherein the case is comprised of a waterproof material.

3. The portable television device of claim 1, wherein the battery is comprised of a removable battery.

4. The portable television device of claim 1, wherein the battery is comprised of a charging port.

5. The portable television device of claim 1, wherein the screen is comprised of a connection port.

6. The portable television device of claim 1, wherein the lid can be secured to the body via a locking mechanism.

7. A portable television device comprising:
a case comprised of a body;
a lid attached to the body via a hinge;
a display screen;
an exterior hinge; and
a battery.

8. The portable television device of claim 7, wherein the exterior hinge is positioned on an exterior surface of the body.

9. The portable television device of claim 8, wherein the exterior hinge is comprised of a mounting bracket.

10. The portable television device of claim 9, wherein the mounting bracket is comprised of an opening.

11. The portable television device of claim 7, wherein the battery is comprised of a non-removable battery.

12. The portable television device of claim 7, wherein the screen is comprised of a connection port.

13. The portable television device of claim 12, wherein the port is comprised of a cover.

14. A method of using a portable television device, the method comprising the following steps:
providing a portable television device comprised of a case comprised of a body comprised of a lid, and a display screen comprised of a battery and a connection port;
opening the lid and folding the lid about a hinge of the case; and
placing the lid on a surface such that the display screen can be viewed.

15. The method of using a portable television device of claim 14, wherein the body is comprised of an exterior hinge.

16. The method of using a portable television device of claim 15, wherein the exterior hinge is comprised of a mounting bracket.

17. The method of using a portable television device of claim 16, wherein the mounting bracket is comprised of an opening.

18. The method of using a portable television device of claim 14, wherein the connection port is comprised of an HDMI port.

19. The method of using a portable television device of claim 14, wherein the connection port is comprised of an ethernet port.

20. The method of using a portable television device of claim 14, wherein the body is comprised of a handle.
